(19) United States
(12) Patent Application Publication
(10) Pub. No.: US 2018/0343804 A1
(43) Pub. Date: Dec. 6, 2018

(54) Kernel Removal System

(71) Applicants: Ginger Hetrich, Harvey, LA (US); Mike Hinojose, Harvey, LA (US)

(72) Inventors: Ginger Hetrich, Harvey, LA (US); Mike Hinojose, Harvey, LA (US)

(21) Appl. No.: 15/615,778

(22) Filed: Jun. 6, 2017

(51) Int. Cl. A01F 11/06; A47J 17/02; A47J 19/00

(52) U.S. Cl. CPC A01F 11/06; A47J 19/00; A47J 17/02

(57) ABSTRACT

The disclosure as detailed herein is in the technical field of kitchen accessories. More specifically, the present disclosure relates to the technical field of food preparation devices. Even more specifically, the present disclosure relates to the technical field of removing kernels from corn. The Kernel Removal System allows a person to remove the kernels from multiple corn cobs in an efficient and clean fashion. The corn is stabilized throughout the removal process and the juices from the corn is collected and then directed away from the working area such that the working surface remains clean and does not impede further work. Additionally, the user is able to prepare multiple cobs for dekernelization such that the time spent removing kernels is dramatically reduced.

### CROSS REFERENCE TO RELATED APPLICATIONS

Not applicable

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of kitchen accessories. More specifically, the present disclosure relates to the technical field of food preparation devices. Even more specifically, the present disclosure relates to the technical field of removing kernels from corn.

### DESCRIPTION OF RELATED ART

When a person attempts to remove kernels from corn there are many difficulties which arise. Namely a person can have difficulty easily securing the corn cob for easy kernel removal. Additionally, a person can experience difficulty removing the kernels from the corn in an even fashion. Furthermore, as the kernels are removed the juices from the corn are prone to spill over the work surface and impede further work by messing up the work area and making it slippery.

### GENERAL SUMMARY OF THE INVENTION

When a person attempts to remove the kernels from corn the person is often unable to securely fix the corn in a stationary position such that both hands are free. Furthermore, a person is often unable to effectively work on more than one corn cob at a time. Additionally, the person is often unable to contain the juices from the corn in an effective and efficient manner such that the juices from the corn cobs which have had the kernels removed impede the working area.

The Kernel Removal System allows a person to remove the kernels from multiple corn cobs in an efficient and clean fashion. The corn is stabilized throughout the removal process and the juices from the corn is collected and then directed away from the working area such that the working surface remains clean and does not impede further work. Additionally, the user is able to prepare multiple cobs for dekernelization such that the time spent removing kernels is dramatically reduced.

### DESCRIPTION OF FIGURES

FIG. 1 is a perspective view, which shows an overall perspective view of the Kernel Removal System.

FIG. 2 is a perspective view, which shows a bottom up perspective view of the board with grip.

FIG. 3 is a perspective view, which shows a bottom up perspective view of the board without gripper.

FIG. 4 is a perspective view, which shows a top down perspective view of the board.

FIG. 5 is a perspective view, which shows a top down perspective view of the board with strainer removed.

FIG. 6 is a perspective view, which shows a top down perspective view of the board without rods.

FIG. 7 is a perspective view, which shows an exploded, bottom up perspective view of the board with sealer.

FIG. 8 is a perspective view, which shows a front perspective view of an attachment unit with sealer.

FIG. 9 is a perspective view, which shows a bottom up perspective view of an attachment unit with gripper on bottom.

FIG. 10 is a perspective view, which shows a top down perspective view of a stopper in the board.

FIG. 11 is a perspective view, which shows a side view perspective of the attachment units with one being removed.

FIG. 12 is a perspective view, which shows a top down perspective view of a dekernelizer.

FIG. 13 is a perspective view, which shows a top down perspective view of a dekernelizer.

FIG. 14 is a perspective view, which shows a top down perspective view of an individual dekernelizer unit with desilking unit.

FIG. 15 is a perspective view, which shows a bottom up perspective view of an individual dekernelizer unit.

FIG. 16 is a diagram of using the Kernel Removal System.

FIG. 17 is a diagram of assembling the Board.

FIG. 18 is a diagram of inserting a Rod.

FIG. 19 is a diagram of preparing food using the Kernel Removal System.

FIG. 20 is a diagram of using the Kernel Removal System with other foods.

### DETAILED DESCRIPTION

One or more different inventions may be described in the present application. Further, for one or more of the inventions described herein, numerous alternative embodiments may be described, it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g, because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

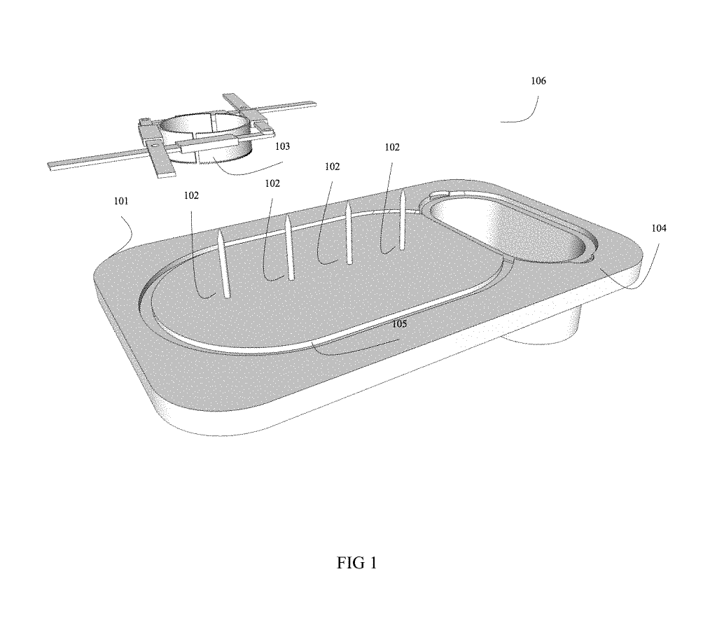

Referring now to FIG. 1, which shows an overall perspective view of the Kernel Removal System.

The board 101 comprises a flat work surface. The board 101 interacts with a dekernelizer 103. The board 101 is preferably shaped like a rectangle. One goal of the board 101 is to provide a means to attach other components of the kernel removal system 106 such as the removable strainer 202 and corn attachment mechanism 801. The board 101 preferably comprises a gutter 105, a strainer region 104, an attachment unit 102, a gripping mechanism 201, and finally, handles 402. The attachment unit 102 comprises a means to attach the corn to the board 101. Spatially, the attachment unit 102 is preferably positioned along the midline of the board 101. In some embodiments, the number of attachment units 102 can be calculated as 4 square inches per area of the board 101. In some embodiments, it is thought that an example of an attachment unit 102 may include double spikes, screw attachments, and the like. The attachment unit 102 preferably comprises a spike aperture 704, a corn attachment mechanism 801, and finally, a stopper 1001. The dekernelizer 103 comprises a mechanical device that allows a user to remove kernels from vegetables. In some embodiments, it is thought that if the dekernelizer 103 is absent then the kernel removal system 106 cannot be used to remove kernels from corn. One goal of the dekernelizer 103 is to remove corn kernels from the corn cob. The dekernelizer 103 preferably comprises a dekernelizer unit 1304, The strainer region 104 comprises a region of the board that is specifically used to aggregate corn and allow juices to flow off of the board 101. In some embodiments, it is thought that if the strainer region 104 is absent then foods and liquids from the food preparation process accumulate on the board 101. One goal of the strainer region 104 is to provide a means to attach a removable strainer 202 to collect excess liquid produced during the food preparation process. The strainer region 104 has an alternative embodiment herein termed the bowl embodiment. The strainer region 104 preferably comprises a strainer aperture 501, and finally, a removable strainer 202. The gutter 105 comprises a channel that wraps around all of the attachment unit 102 and operably interacts with the strainer aperture 501. Spatially, the gutter 105 is preferably positioned around the perimeter of the board. The gutter 105 is preferably shaped like a cylinder, triangle, rectangle, or radius corned gutter. In some embodiments, the depth of the gutter 105 can be calculated by the depth of the board such that the board does not break. In some embodiments, it is thought that if the gutter 105 is absent then the board 101 will still work but it will be really messy. One goal of the gutter 105 is to channel the juice from the corn into the strainer aperture 501. The kernel removal system 106 comprises a system that can be used to remove Kernels from corn. The kernel removal system 106 functions to both 1) remove corn kernels from the corn cob and to 2) remove maize Kernels from the cob. The kernel removal system 106 comprises a dekernelizer 103 and a board 101.

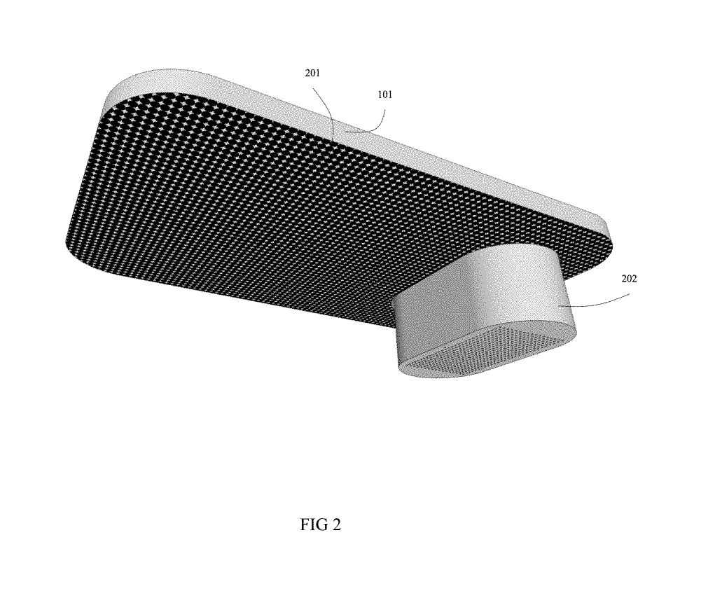

Referring now to FIG. 2, which shows a bottom up perspective view of the board with grip.

The gripping mechanism 201 comprises a means for the board 101 to not lose its grip when in use. Spatially, the gripping mechanism 201 is preferably positioned attached to the bottom of the board 101. The gripping mechanism 201 is mainly thought to be composed of rubber. In some embodiments, it is thought that an example of a gripping mechanism 201 may include a footing, a flat rubber base glued to the bottom, gripping on one or more spike base 301, and the like. In some embodiments, it is thought that if the gripping mechanism 201 is absent then the board 101 may be used without the gripping mechanism 201. The removable strainer 202 comprises an object with perforations that allows juices to flow through while preventing larger objects from passing through. In some embodiments, it is thought that an example of the removable strainer 202 could be a colander or perhaps a filter and the like. In some embodiments, it is thought that if the removable strainer 202 is absent then foods and liquids will fall through the strainer aperture 501.

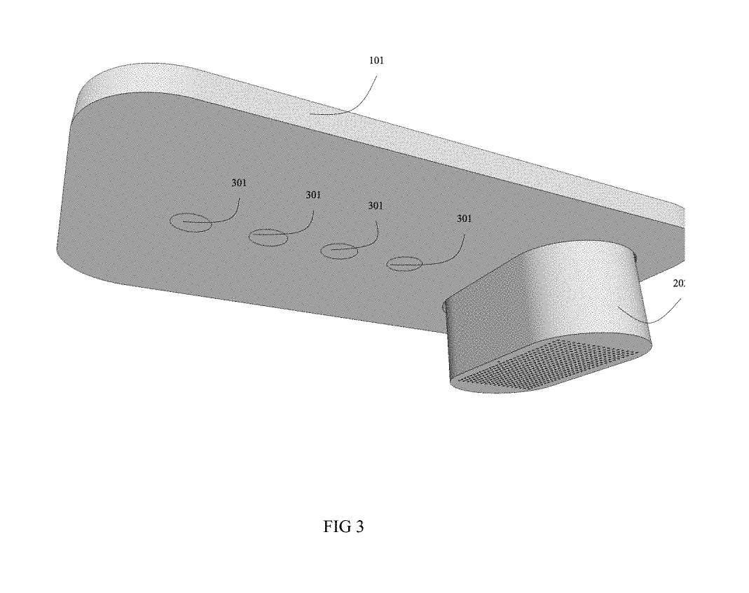

Referring now to FIG. 3, which shows a bottom up perspective view of the board without gripper.

The spike base 301 comprises a perpendicular structure to the rod 401 that provides stability for the rod 401 and prevents lateral movement of the rod 401. Spatially, the spike base 301 is preferably positioned perpendicular to the rod 401 to form a perpendicular base. The spike base 301 is preferably shaped like a circle however, it is thought that in alternative embodiments that it may also be shaped like a rectangle, triangle, square, or any shape which supports the base. The spike base 301 is mainly thought to be composed of “304 stainless steel”, or stainless steel. In some embodiments, the spike base 301 has a preferred diameter of 1.25 inches but in some embodiments, may range from a minimum of 1 inches to a maximum diameter of 3 inches. In some embodiments, the spike base 301 has a preferred height of 1/16 inches but in some embodiments, may range from a minimum of 1/32 inches to a maximum height of ¼ inches. In some embodiments, the height of the spike base 301 can be calculated as the depth of the large recession 703. The spike base 301 has many purposes which are as follows: First, the purpose of the spike base 301 is to support the base. Next, it serves to provide a flush surface on the bottom of the board 101 so that the board 101 is stable when placed on a working surface. Lastly, the spike base 301 serves to recess into the large recession 703 to form a flat bottom surface of the board 101.

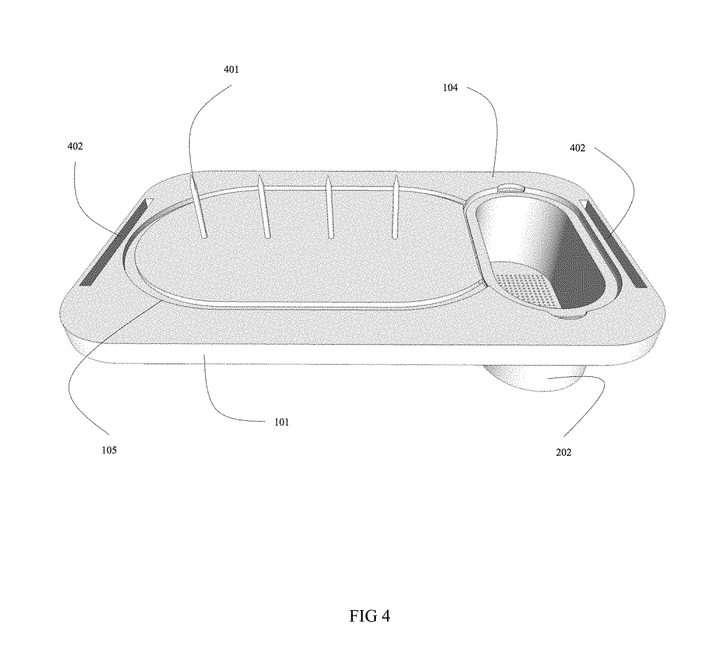

Referring now to FIG. 4, which shows a top down perspective view of the board.

The rod 401 comprises a spike that may be inserted into the board 101 to be used for impaling food to the work surface. Spatially, the rod 401 is preferably positioned in the rod aperture 601 of the board 101. In some embodiments, the rod 401 has a preferred height of 4 inches but in some embodiments, may range from a minimum of 2.5 inches to a maximum height of 6 inches. The handles 402 comprise a means to grasp the board 101 to move it around. Spatially, the handles 402 is preferably positioned on the end of the board next to the strainer region 104 and at the end of the board 101 opposite the strainer region 104. In some embodiments, it is thought that if the handles 402 are absent then the board 101 may be used without handles 402.

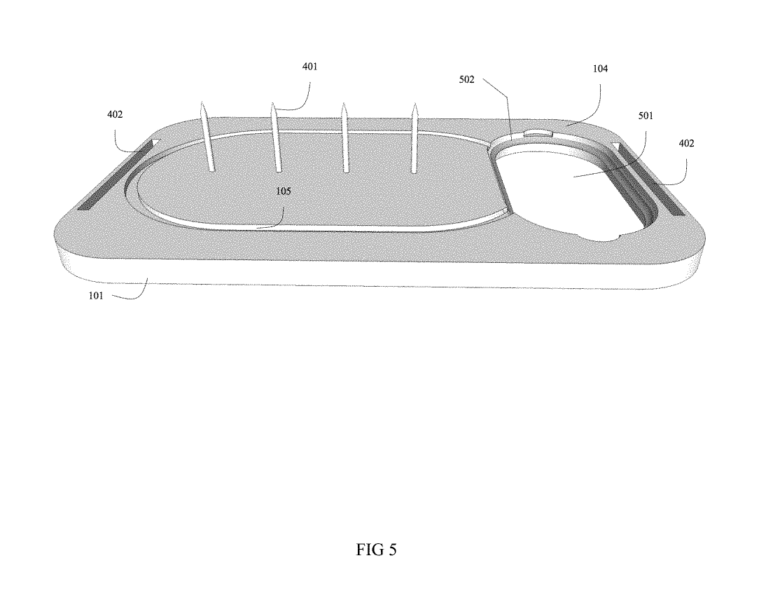

Referring now to FIG. 5, which shows a top down perspective view of the board with strainer removed.

The strainer aperture 501 comprises a hole in the strainer region 104 of the board 101. One goal of the strainer aperture 501 is to allow for seating of the removable strainer 202. The strainer aperture 501 preferably comprises a removable strainer recession 502. The removable strainer recession 502 comprises a recession around the edge of the strainer aperture 501. Spatially, the removable strainer recession 502 is preferably positioned around the edge of the strainer aperture 501. In some embodiments, the depth of the removable strainer recession 502 can be calculated by that which allows the top of the removable strainer 202 to be flush with the bottom of the gutter 105. One goal of the removable strainer recession 502 is to ensure that the removable strainer sits flush with the bottom of the gutter 105.

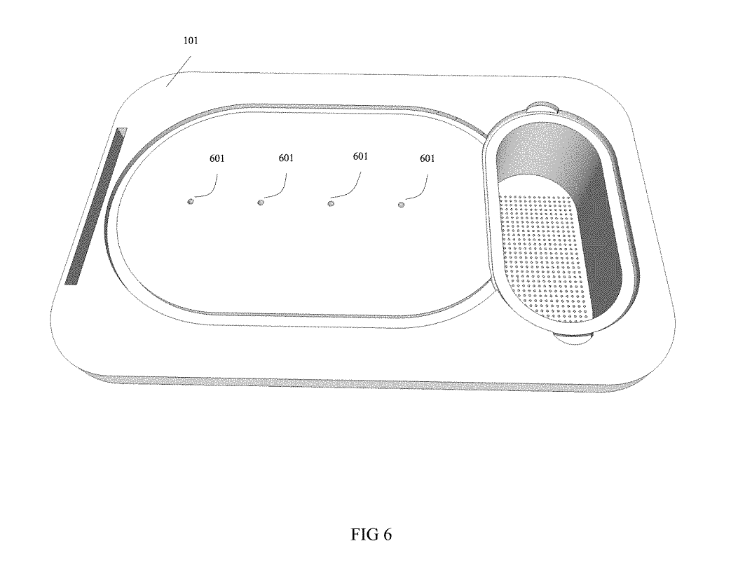

Referring now to FIG. 6, which shows a top down perspective view of the board without rods.

The rod aperture 601 comprises the aperture that seats the rod 401 into the board 101. Spatially, the rod aperture 601 is preferably positioned in the small recession 702 and through the board 101. In some embodiments, the diameter of the rod aperture 601 can be calculated by matching it to the outside diameter of the rod 401.

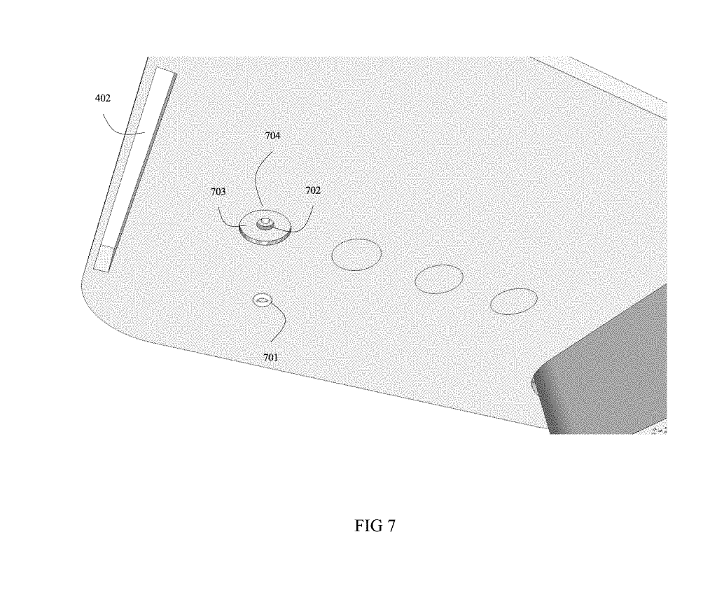

Referring now to FIG. 7, which shows an exploded, bottom up perspective view of the board with sealer.

The sealer 701 comprises a gasket that forms a watertight seal between the spike base 301 and the board 101. The sealer 701 interacts with the spike base 301 and the board 101. The sealer 701 is attached to the spike base 301. Spatially, the sealer 701 is preferably positioned between the spike base 301 and the board 101. The sealer 701 is mainly thought to be composed of rubber. In some embodiments, it is thought that if the sealer 701 is absent then some of the juices spill out beneath the board. The small recession 702 comprises the aperture that seats the sealer 701. Spatially, the small recession 702 is preferably positioned within the large recession 703 of the board 101. In some embodiments, the diameter of the small recession 702 can be calculated by matching it to the diameter of the sealer 701. The large recession 703 comprises the aperture that seats the spike base 301 into the board 101. Spatially, the large recession 703 is preferably positioned ventral to the small recession 702. In some embodiments, the diameter of the large recession 703 can be calculated by matching it to the diameter of the spike base 301 and preferably is ¼ the length of the corn attachment mechanism 801. One goal of the large recession 703 is that it is a recession into the board 101 that allows the board 101 to sit flush on a working surface. The spike aperture 704 comprises a means to attach the corn attachment mechanism 801 to the board 101. Spatially, the spike aperture 704 is preferably positioned in a row in the middle of the board, parallel to its length and perpendicular to its width. The spike aperture 704 is preferably shaped like a circle, however, it is thought that in alternative embodiments that it may also be shaped like a square, a rectangle, or a triangle. The spike aperture 704 preferably comprises a large recession 703, a small recession 702, and finally, a rod aperture 601.

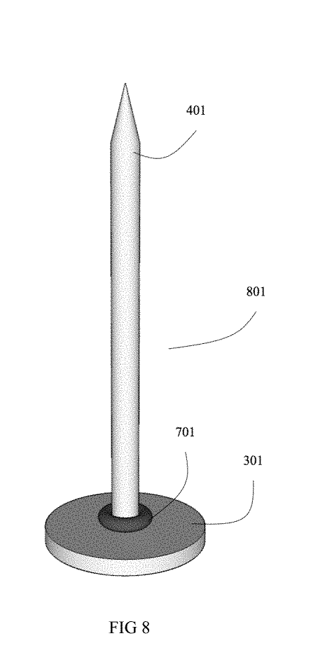

Referring now to FIG. 8, which shows a front perspective view of an attachment unit with sealer.

The corn attachment mechanism 801 comprises a means to impale the corn to secure the corn in a stable vertical position for use of the dekernelizer 103. The corn attachment mechanism 801 is attached to the board 101. The corn attachment mechanism 801 has multiple alternative embodiments herein termed a “multiple spiked” embodiment and a “screw type” embodiment. The corn attachment mechanism 801 preferably comprises a rod 401, a spike base 301, a sealer 701, and finally, a spike base gripper 901.

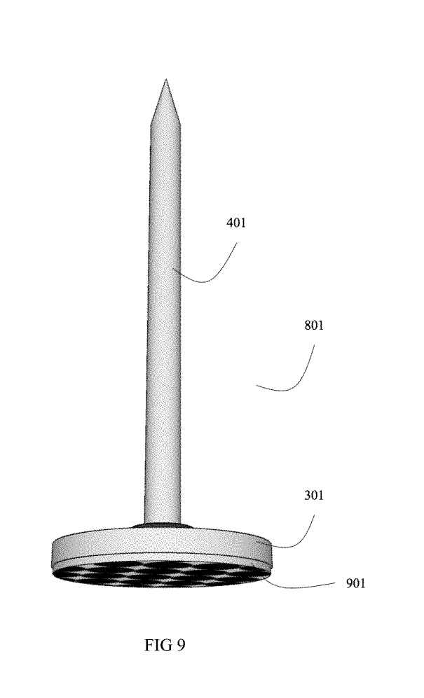

Referring now to FIG. 9, which shows a bottom up perspective view of an attachment unit with gripper on bottom.

The spike base gripper 901 comprises a means for the spike base 301 to not lose its grip when in use. Spatially, the spike base gripper 901 is preferably positioned at the bottom of the spike base 301. The spike base gripper 901 is preferably shaped like a circle. In some embodiments, it is thought that if the spike base gripper 901 is absent then the spike base 301 may still be used. One goal of the spike base gripper 901 is to keep it from sliding while the kernel removal system 106 in use.

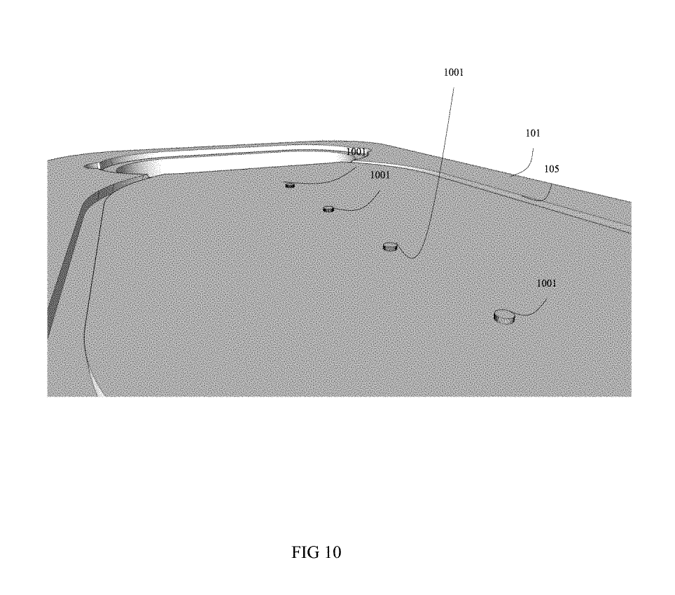

Referring now to FIG. 10, which shows a top down perspective view of a stopper in the board.

The stopper 1001 comprises a mechanism to plug the rod aperture 601 when a user does not wish to insert a corn attachment mechanism 801. In some embodiments, it is thought that if the stopper 1001 is absent then liquids and/or foods may spill through the rod aperture 601.

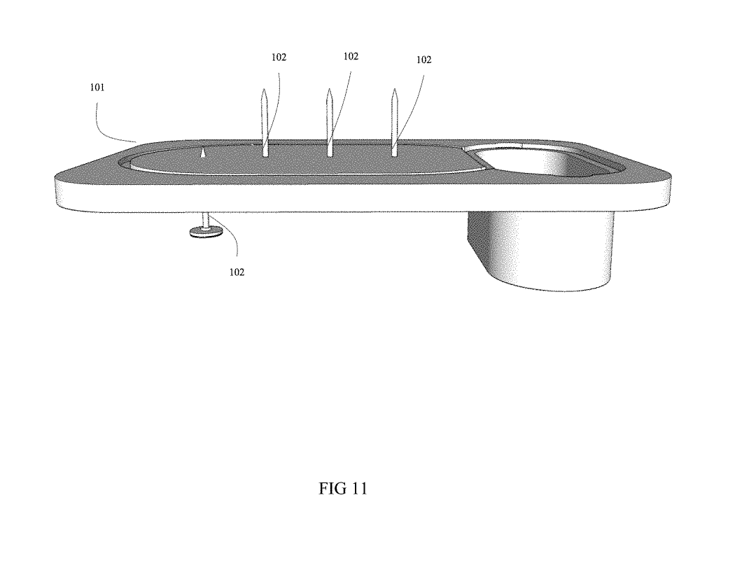

Referring now to FIG. 11, which shows a side view perspective of the attachment units with one being removed.

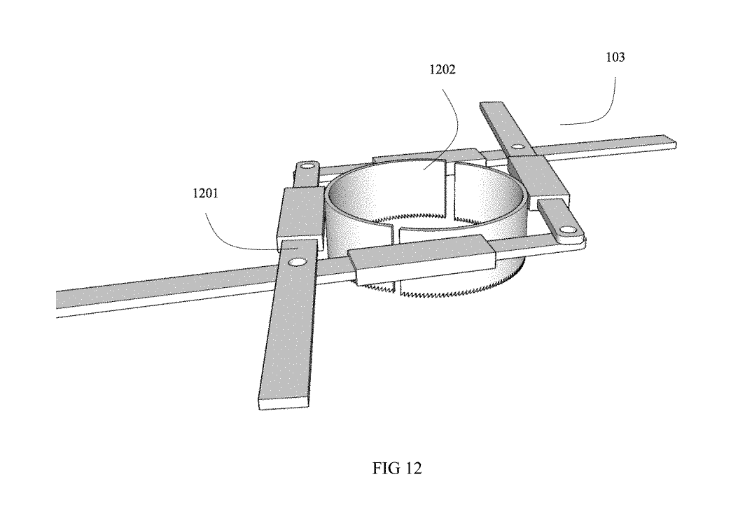

Referring now to FIG. 12, which shows a top down perspective view of a dekernelizer.

The actuator rod 1201 comprises one half of the dekernelizer unit 1304 that interacts with the opposite side through the hinge attachment mechanism. The actuator rod 1201 is preferably shaped like a cylinder. The actuator rod 1201 is mainly thought to be composed of stainless steel, however other embodiments may be composed of any of the following: hard composite, 304 stainless steel, or dishwasher safe composite. The actuator rod 1201 preferably comprises a handle flat section 1303, and finally, an interior section 1302. The chopping unit 1202 comprises the chopping mechanism. The chopping unit 1202 interacts with the corn which is to have kernels removed. Spatially, the chopping unit 1202 is preferably positioned next to the gripping section 1401. In some embodiments, the width of the chopping unit 1202 can be calculated by half the circumference of the average sized piece of corn. In some embodiments, the chopping unit 1202 has a preferred height of 1 inch inches but in some embodiments, may range from a minimum of 0.5 inches to a maximum height of 2 inches. In some embodiments, the height of the chopping unit 1202 can be calculated by the minimum amount that allows for effective guidance of the corn. The chopping unit 1202 has an alternative embodiment herein termed an electric operated serrated edge. The chopping unit 1202 preferably comprises a serrated edge 1407, a front surface 1406, and finally a back surface 1501.

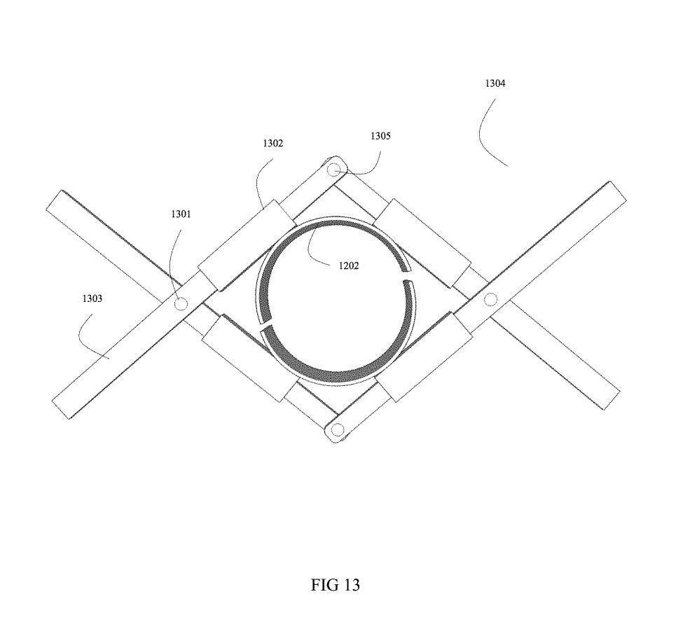

Referring now to FIG. 13, which shows a top down perspective view of a dekernelizer.

The attachment mechanism 1301 comprises an interaction component that allows scissoring between two handle flat sections 1303. Spatially, the attachment mechanism 1301 is preferably positioned interior to the gripping section 1401. In some embodiments, it is thought that an example of the attachment mechanism 1301 could be a screw and bolts, or perhaps rivets and the like. The attachment mechanism 1301 preferably comprises an attachment aperture 1403. The interior section 1302 comprises a region of the actuator rod 1201 that is located between two of the hinge attachment mechanisms 1305. The interior section 1302 is preferably shaped like a cylinder. In some embodiments, it is thought that an example of the interior section 1302 could be a hollow shaped section or perhaps a solid section and the like. The interior section 1302 has many purposes which are as follows: First, the purpose of the interior section 1302 is to provide stability for the actuator rod 1201. Next, it serves to provide surface area for attachment of the chopping unit 1202. Lastly, the interior section 1302 serves to provide lateral strength to the actuator rod 1201. The interior section 1302 preferably comprises a hinge attachment mechanism 1305. The handle flat section 1303 comprises the section of the actuator rod 1201 that allows the gripping and scissoring functions for removing the kernels. The handle flat section 1303 functions to both 1) allow gripping and to 2) allow scissoring. The handle flat section 1303 has an alternative embodiment herein termed a “Same Shape”. The handle flat section 1303 preferably comprises an attachment mechanism 1301, a gripping section 1401, a handle outward surface 1404, and finally a handle scissoring surface 1503. The dekernelizer unit 1304 comprises one side of the dekernelizer 103 that when squeezed with the opposite side compresses the serrated edge 1407 to the diameter of the corn cob that allows a downward motion to remove the maximum amount of kernels. One goal of the dekernelizer unit 1304 is to collapse and interact with the actuator rod 1201 in order to compress the chopping unit 1202. The dekernelizer unit 1304 comprises an actuator rod 1201 and a chopping unit 1202. The hinge attachment mechanism 1305 comprises one end region of the actuator rod 1201 which allows scissoring. Spatially, the hinge attachment mechanism 1305 is preferably positioned at the end of the actuator rod 1201 opposite the gripping section 1401. The hinge attachment mechanism 1305 preferably comprises a hinge aperture 1402, a outward face 1405, and finally a scissoring face 1504.

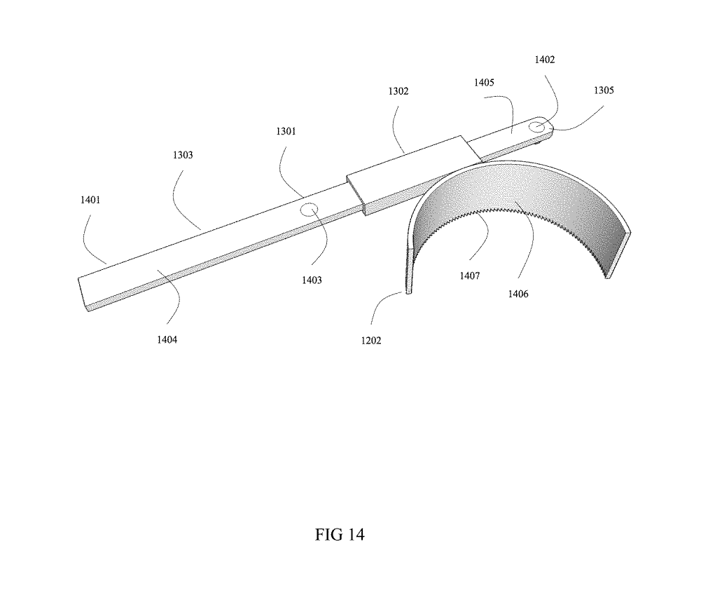

Referring now to FIG. 14, which shows a top down perspective view of an individual dekernelizer unit.

The gripping section 1401 comprises a region on the end of the handle flat section 1303 which allows one to grasp the dekernelizer 103 and orient the dekernelizer 103 perpendicular to the corn. Spatially, the gripping section 1401 is preferably positioned at the end of the handles 402 opposite the dekernelizer 103. In some embodiments, the length of the gripping section 1401 can be calculated by that which allows one to grasp the gripping section 1401. In some embodiments, it is thought that if the gripping section 1401 is absent then it is harder for a user to operate the kernel removal system 106 because the handle will be shorter, thereby limiting the force applied. The gripping section 1401 has an alternative embodiment herein termed a scissor handle embodiment. The hinge aperture 1402 comprises an insertion through the interior section 1302 of the actuator rod 1201 that allows for the hinge to attach to the actuator rod 1201. The hinge aperture 1402 interacts with one or more actuator rods 1201. The attachment aperture 1403 comprises an insertion through the handle flat section 1303 that allows the scissoring action to occur. Spatially, the attachment aperture 1403 is preferably positioned midway on the handles 402. In some embodiments, it is thought that if the attachment aperture 1403 is absent then an alternative means for attaching two handle flat section 1303 can be used which still allow for a scissoring action. The handle outward surface 1404 comprises the outward surface of the handle flat section 1303 that interacts with the person that is using the dekernelizer 103. The outward face 1405 comprises the outward surface of the hinge attachment mechanism 1305. Spatially, the outward face 1405 is preferably positioned opposite the scissoring face 1504. The front surface 1406 comprises the interior surface of the chopping unit 1202. Spatially, the front surface 1406 is preferably positioned facing inwards towards the corn on the chopping unit 1202. The serrated edge 1407 comprises a toothed edge that allows for cutting. The serrated edge 1407 interacts with the corn. Spatially, the serrated edge 1407 is preferably positioned on the chopping unit 1202. In some embodiments, it is thought that if the serrated edge 1407 is absent then kernels are smashed and scraped rather than cut.

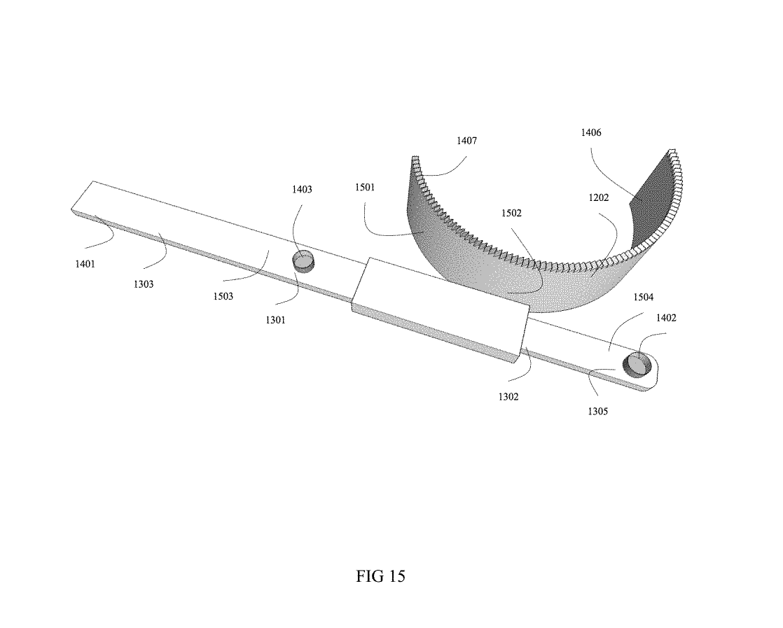

Referring now to FIG. 15, which shows a bottom up perspective view of an individual dekernelizer unit.

The back surface 1501 comprises the exterior surface of the chopping unit 1202. Spatially, the back surface 1501 is preferably positioned facing outwards on the chopping unit 1202. The back surface 1501 preferably comprises a chopping unit attachment mechanism 1502. The chopping unit attachment mechanism 1502 comprises a means to attach the chopping unit 1202 to the dekernelizer unit 1304. Spatially, the chopping unit attachment mechanism 1502 is preferably positioned between the chopping unit 1202 and the actuator rod 1201. In some embodiments, it is thought that an example of a chopping unit attachment mechanism 1502 may include a tack weld, rivet, and the like. The handle scissoring surface 1503 comprises a region of the handle flat section 1303 which permits the scissoring action of the actuator rod 1201 by interacting with the oppositely faced handle scissoring surface 1503. Spatially, the handle scissoring surface 1503 is preferably positioned interior to the attachment mechanism 1301. The handle scissoring surface 1503 is preferably shaped like a flat bar. The scissoring face 1504 comprises a region of the hinge attachment mechanism 1305 which permits the scissoring action of the actuator rod 1201 by interacting with the oppositely faced hinge attachment mechanism 1305. Spatially, the scissoring face 1504 is preferably positioned opposite the outward face 1405.

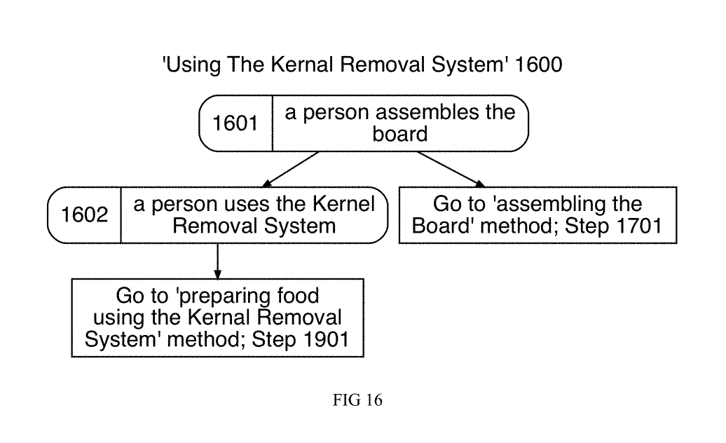

Referring now to FIG. 16, which shows using the Kernel Removal System.

In a first step, a person assembles the board 101 (Step 1601). This is further detailed below in a related method (1700—‘assembling the Board’). Next, a person uses the kernel removal system 106 (Step 1602). This is further detailed below in a related method (1900—‘preparing food using the Kernel Removal System’).

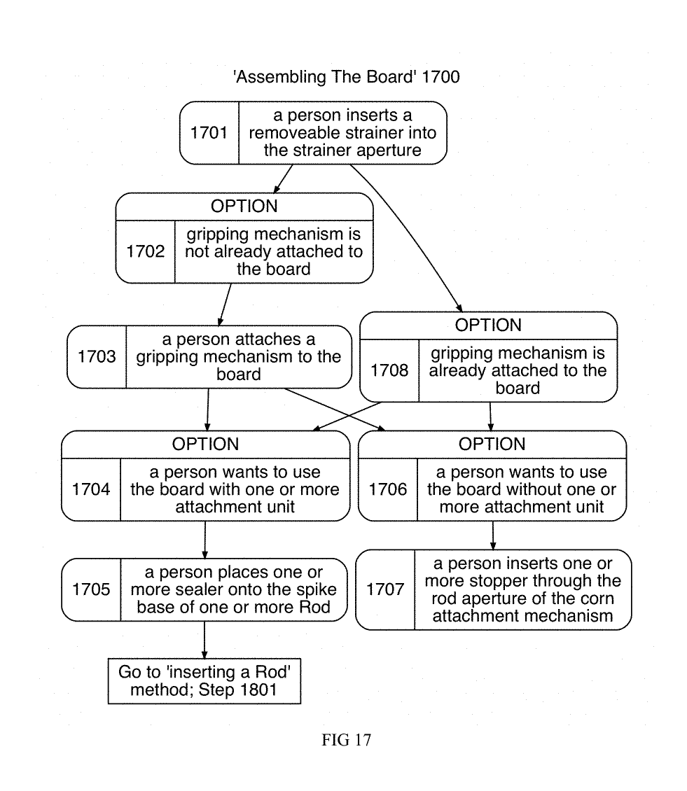

Referring now to FIG. 17, which shows assembling the Board.

In a first step, a person inserts a removable strainer 202 into the strainer aperture 501 (Step 1701). If a gripping mechanism 201 is not already attached to the board 101 (Step 1702), then a person attaches a gripping mechanism 201 to the board 101 (Step 1703). If a person wants to use the board 101 with one or more attachment units 102 (Step 1704), then a person places one or more sealers 701 onto the spike base 301 of one or more rods 401 (Step 1705). This is further detailed below in a related method (1800—‘inserting a rod’). From Step 1703, if a person wants to use the board 101 without one or more attachment units 102 (Step 1706), then a person inserts one or more stoppers 1001 through the rod aperture 601 of the corn attachment mechanism 801 (Step 1707). From Step 1701, if a gripping mechanism 201 is already attached to the board 101 (Step 1708), then refer to Step 1704. From Step 1703, then refer to Step 1706.

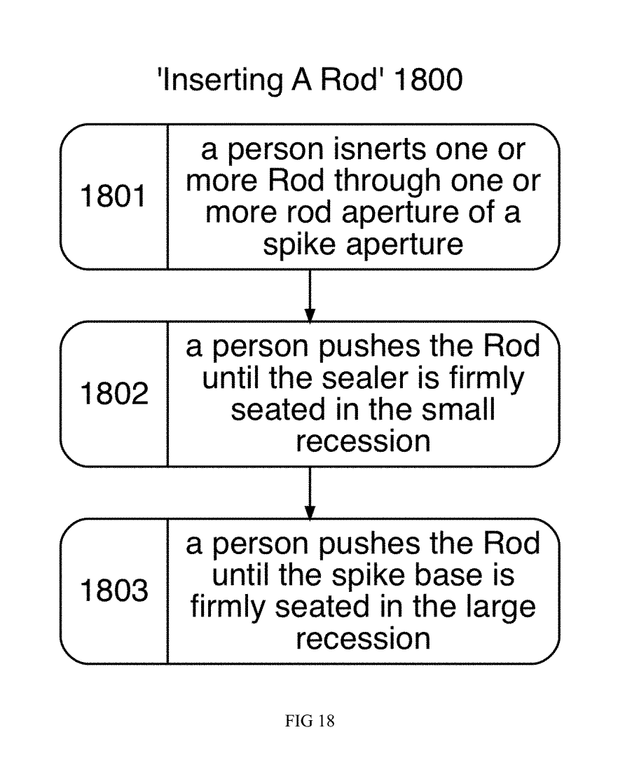

Referring now to FIG. 18, which shows inserting a Rod.

In a first step, a person inserts one or more rods 401 through one or more rod apertures 601 of a spike aperture 704 (Step 1801). Next, a person pushes the rod 401 until the sealer 701 is firmly seated in the small recession 702 (Step 1802). Next, a person pushes the rod 401 until the spike base 301 is firmly seated in the large recession 703 (Step 1803).

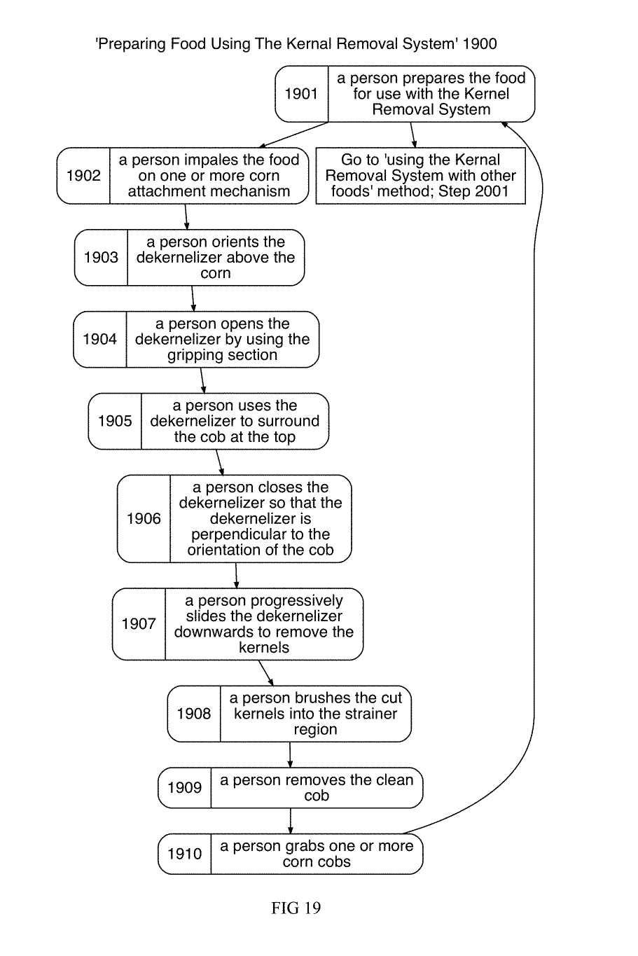

Referring now to FIG. 19, which shows preparing food using the Kernel Removal System.

In a first step, a person prepares the food for use with the kernel removal system 106 (Step 1901). This is further detailed below in a related method (2000—‘using the Kernel Removal System with other foods’). Next, a person impales the food on one or more corn attachment mechanisms 801 (Step 1902). Next, a person orients the dekernelizer 103 above the corn (Step 1903). Next, a person opens the dekernelizer 103 by using the gripping section 1401 (Step 1904). Next, a person uses the dekernelizer 103 to surround the cob at the top (Step 1905). Next, a person closes the dekernelizer 103 so that the dekernelizer 103 is perpendicular to the orientation of the cob (Step 1906). Next, a person progressively slides the dekernelizer 103 downwards to remove the kernels (Step 1907). Next, a person brushes the cut kernels into the strainer region 104 (Step 1908). Next, a person removes the clean cob (Step 1909). Next, a person grabs one or more corn cobs (Step 1910).

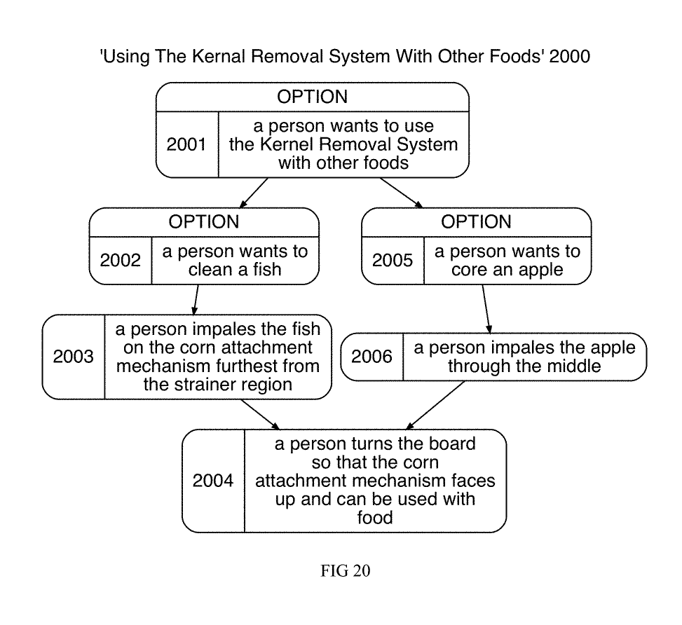

Referring now to FIG. 20, which shows using the Kernel Removal System with other foods.

If a person wants to use the kernel removal system 106 with other foods (Step 2001), and if a person wants to clean a fish (Step 2002), then a person impales the fish on the corn attachment mechanism 801 furthest from the strainer region 104 (Step 2003). Next, a person turns the board 101 so that the corn attachment mechanism 801 faces up and can be used with food (Step 2004). From Step 2001, if a person wants to core an apple (Step 2005), then a person impales the apple through the middle (Step 2006). Next, refer to Step 2004.

What is claimed is:

1. A kernel removal system comprising:
a. A board; and a
b. dekernelizer

2. The apparatus of claim 1 wherein the board further comprises
a. a handles;
b. a gripping mechanism;
c. one or more attachment unit;
d. a gutter; and
e. a strainer region

3. The apparatus of claim 2 wherein the attachment unit further comprises:
a. a spike aperture;
b. a stopper; and a corn attachment mechanism.

4. The apparatus of claim 3 wherein the spike aperture further comprises:
a. a large recession;
b. a small recession; and
c. a rod aperture,
and where the corn attachment mechanism further comprises:
a. one or more rod;
b. a spike base;
c. a spike base gripper; and
d. a sealer

5. The apparatus of claim 2 wherein the strainer region further comprises
a. A strainer aperture; and
b. A removable strain

6. The apparatus of claim 5 wherein the strainer aperture further comprises a removable strainer recession

7. The apparatus of claim 1 wherein the dekernelizer further comprises a dekernelizer unit, wherein said dekernelizer unit further comprises:
a. an actuator rod; and
b. a chopping unit.

8. The apparatus of claim 7 wherein the actuator rod further comprises:
a. a handle flat section; and
b. an interior section which further comprises a hinge attachment mechanism.

9. The apparatus of claim 8 wherein the handle flat section further comprises:
a. a gripping section;
b. an attachment mechanism which further comprises an attachment aperture;
c. a handle scissoring surface; and
d. a handle outward surface.

10. The apparatus of claim 7 wherein the hinge attachment mechanism further comprises:
a. an outward face;
b. a scissoring face; and
c. a hinge aperture.

11. The apparatus of claim 7 wherein the chopping unit further comprises:
a. a serrated edge;
b. a back surface which further comprises a chopping unit attachment mechanism; and
c. a front surface.

12. The apparatus of claim 4 wherein the rod has a diameter which ranges from 1 inch to 3 inches.

13. The apparatus of claim 4 wherein the rod has a height ranging from 1/32 inches to 1.4 inches

14. The apparatus of claim 7 wherein the chopping unit has a height ranging from 0.5 inches to 2 inches.

15. The apparatus of claim 2 wherein the attachment unit count ranges from 1 to 4.
